(19) United States
(12) Patent Application Publication
(10) Pub. No.: US 2009/0315828 A1
(43) Pub. Date: Dec. 24, 2009

(54) APPARATUS WITH MULTIDIRECTIONAL KAY FOR CURSOR CONTROL

(76) Inventor: Hwai Kiang Tan, Singapore (SG)

Correspondence Address: PHILIPS INTELLECTUAL PROPERTY & STANDARDS, P.O. BOX 3001, BRIARCLIFF MANOR, NY, 10510, US

(21) Appl. No.: 12/373,755

(22) PCT Filed: Jul. 11, 2007
(86) PCT No.: PCT/IB07/52762

§ 371 Date: Jan. 14, 2009

(30) Foreign Application Priority Data
Jul. 19, 2006 (EP) 06117446.2

(51) Int. Cl. G06F 3/033

(52) U.S. Cl. 345/157

(57) ABSTRACT

A multidirectional key for control of a cursor has an arrangement of multiple contacts facing another arrangement of multiple fingers and a sliding component between the arrangements. The component selectively enables a specific one of the contacts and a specific one of the fingers to touch one another depending on a specific position of the component relative to the arrangement. The pair of finger and contact touching each other is indicative of the relative position of the sliding component and can therefore be used to control the movement of the cursor.

### FIELD OF THE INVENTION

The invention relates to an apparatus having a user input with a multidirectional key, and to the multidirectional key.

### BACKGROUND ART

There exist various embodiments of multidirectional input devices for moving a cursor, a highlight or another indicium (hereinafter jointly referred to as: cursor) on a display monitor. These embodiments include the computer-mouse and the joystick. The mouse or joystick can be implemented as a separate device or, alternatively, as being physically integrated in a data processing apparatus or in another accessory. Examples of such apparatus include a handheld remote control, a laptop computer or a palmtop computer. An example of an accessory is a keyboard. The control mechanism of an integrated mouse can be implemented as a multidirectional key using a pressure contact design, or force-sensitive resistors (FSR). In the FSR implementation, the user uses his/her thumb to apply a pressure to a fixed-position disc to activate the mouse movement. For the integrated joystick, the user uses the thumb to roll the anchored stick for control of the cursor movement.

Known examples of multidirectional keys are briefly discussed below. JP2004031177 discloses a multidirectional input key penetrating an annular hole in the top face of a housing. The user can slide the key within the plane of the top, its travel being limited by the wall of the hole. The key sits on a flexible key seat that engages with fixed positions in the housing so as to drive the key back to a neutral position upon the user releasing the key. The bottom of the key seat is profiled and engages with a membrane switch configuration that has four contacts, one for each main direction. Sliding the key in a specific direction causes the profiled bottom to close the associated one of the contacts.

JP2004171924 discloses a multidirectional input key that can slide within a housing. The key has a lower part that is held in a neutral position between with two flexible, electrically conductive elements arranged in the plane of the lower part. Pushing the key in a certain direction deforms one of the elements against the wall of the housing. Each element can touch one of two electric contacts in the wall. Which one of the contacts is being touched depends on the element's deformation, which in turn is governed by the direction wherein the key is being pushed.

Further examples of multi-directional keys are being disclosed in JP59206932, JP09134248; and JP5204539.

### SUMMARY OF THE INVENTION

It is one of the objects of the invention is to provide an alternative and simple design for a multidirectional key. To this end, the inventor proposes a system according to claim 1 and a multidirectional key for use in such a system. Mechanical implementations of a multidirectional key in the invention are addressed in claims 2-5. These mechanical implementations are very simple and inexpensive. This is important in low-cost applications, such as in inexpensive mass-produced remote control devices wherein every penny saved is critical to the commercial success. Although rugged, simple and inexpensive, the mechanical implementation does not lend itself well to being scaled to smaller size. A reliable operation requires that the contact fingers be of at least a minimum size, given their being made of a certain material. An alternative then is an optical implementation addressed in further detail below.

### BRIEF DESCRIPTION OF THE DRAWING

The invention is explained in further detail, by way of example and with reference to the accompanying drawing wherein:

FIG. 1 is a diagram of an apparatus in the invention;

FIG. 2 illustrates an example of the mechanical configuration of a multidirectional key in the invention;

FIGS. 3, 4, and 5 illustrate the operational use of a multidirectional key in the invention;

FIGS. 6 and 7 illustrate embodiments of some parts of a multidirectional key in the invention; and

FIGS. 8 and 9 illustrate other examples of a multidirectional key in the invention.

Throughout the figures, same reference numerals indicate similar or corresponding features.

### DETAILED EMBODIMENTS

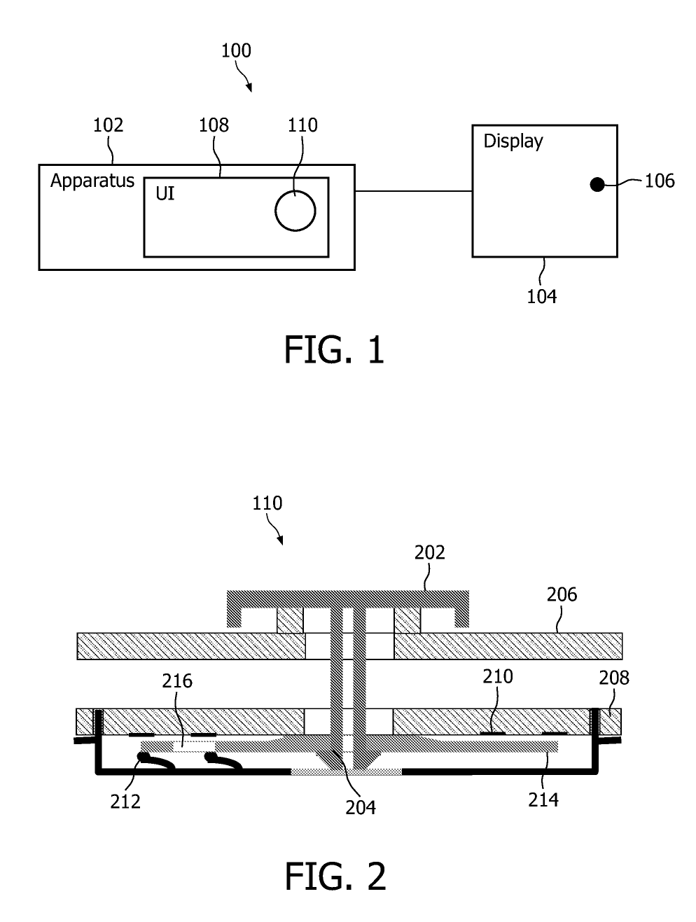

FIG. 1 is a diagram of a system 100 in the invention, comprising an apparatus 102, here a remote control device, and a data processing system having a display monitor 104. Remote control 102 is operative to control, among other things, the movement of a cursor 106 on display monitor 104. Such systems are known in the art and are not discussed in further detail here. Remote control 102 has a user-interface 108 that accommodates a multidirectional key 110 for control of cursor 106. Key 110 is moveable relative to a housing of remote control 102 for converting a movement of the key in a specific direction into a signal representative of this specific direction.

FIG. 2 is a diagram of a cross section of a first example of key 110. Key 110 comprises a slider disc 202 that is connected to a shaft 204 extending through a hole in housing 206 of remote control 102 and through another hole in a printed circuit board (PCB) 208. PCB 208 comprises a first arrangement of multiple contacts 210, of which four are shown in diagram 200. Key 110 further comprises a second arrangement of multiple contact fingers 212, here connected to one another in a web connected to PCB 208. Not all fingers 212 are shown in order to not obscure the drawing. Each of fingers 212 extends towards an associated one of contacts 210. Key 110 further comprises a component 214 moveable between the arrangement of contacts 210 and the arrangement of fingers 212. Component 214 has a plurality of holes, such as hole 216, so as to selectively enable a specific one of fingers 212 to touch a specific associated one of contacts 210 through a specific one of the holes. Which finger touches its associated contact depends on the specific position of component 214 relative to fingers 212 and contacts 210. If a voltage is applied between, on the one side, a contact 210 and, on the other side, a finger 212 touching that contact, then the relative position of component 214 can be determined and thus the direction wherein disc 202 has slid. This direction is then representative of the intended direction wherein cursor 106 should move. Circuitry (not shown) on PCB 208 could poll contacts 210 one after the other in a round robin fashion by applying a voltage to a single contact one at a time, while keeping fingers 212 grounded or connected to another electrical component (not shown). Fingers 212 need not be connected to one another in a web, as specified above, but could be separate features, connected in parallel to multiple other electrical components. What is relevant here is that a voltage drop at a specific one of contacts is then indicative of a finger touching the contact, and therefore of the position of a hole in component 214. As an alternative, all contacts could be carrying the same voltage, and the current could be measured flowing through a contact to a touching finger, thus revealing the relative position of component 214.

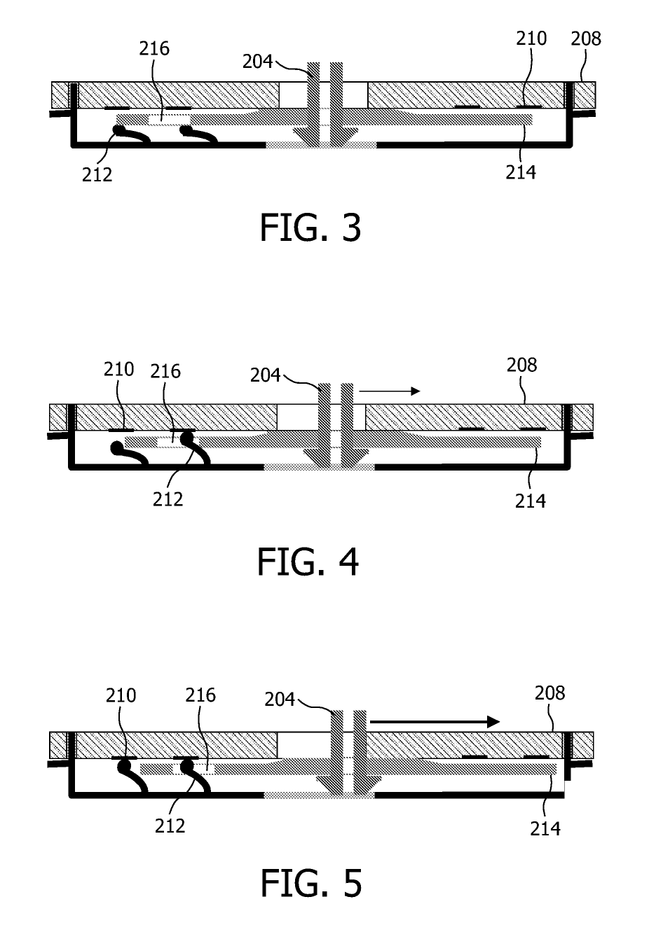

FIGS. 3-5 illustrate the operation of key 110. In FIG. 3, key 110 assumes a neutral position. Component 214 prevents fingers 212 from touching contacts 210. In FIG. 4, slider disc 202 is slid towards the right so that hole 216 gets aligned with a first pair of a specific one of contacts 210 and a specific associated one of fingers 212. This enables the relevant finger to touch the associated contact. In FIG. 5, slider disc 202 is slid to the right even further. Now, the first pair of contact and finger as well as a second pair of another contact and another finger are enabled to touch. This allows not only determining the direction of sliding, but also allows to discriminate between two operational modes of apparatus 102 corresponding with the same direction. Consider the example wherein key 110 is being used to control the movement of cursor 106. In the operational mode wherein there is a single pair of contact and finger touching each other, cursor 106 is moving at a first speed in the direction indicated. In the operational mode wherein there are two pairs touching, cursor 106 is moving at a second speed, e.g., higher than the first speed. By properly adjusting the size of component 214, the sizes of holes 216 and the relative distances between adjacent contacts 210, different operational modes can be created wherein different numbers of pairs of contact and finger are touching each other.

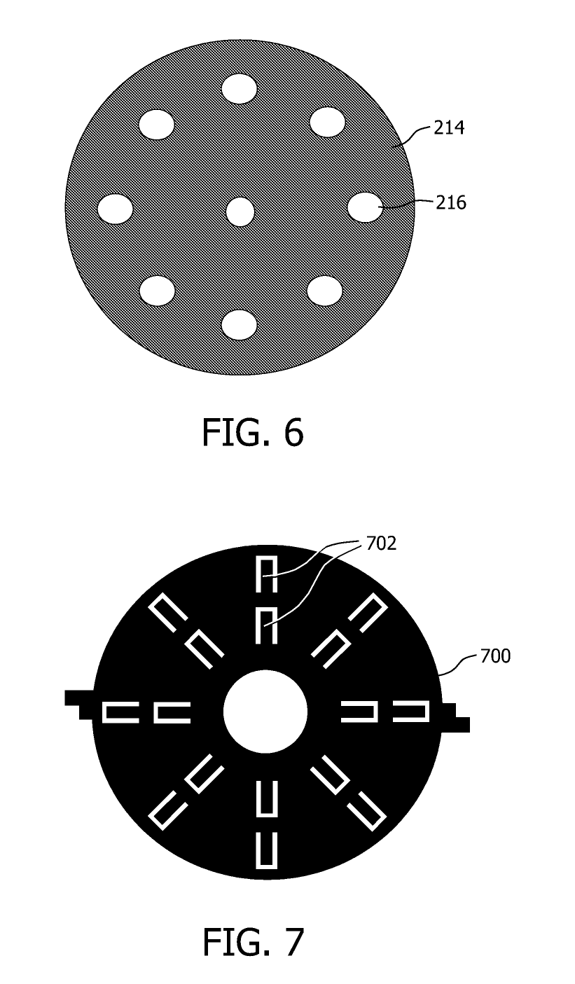

FIGS. 6 and 7 illustrate in planform an example of the configuration of component 214 and of a flat sheet of metal 700 that is to form the web of fingers 212, respectively. In the example shown, sheet 700 comprises multiple slots in the shape of the letter “U”. Fingers 212 are then formed by bending metal pieces 702 out of the plane of sheet 700, so that pieces 702 stick out, all on the same side of the plane.

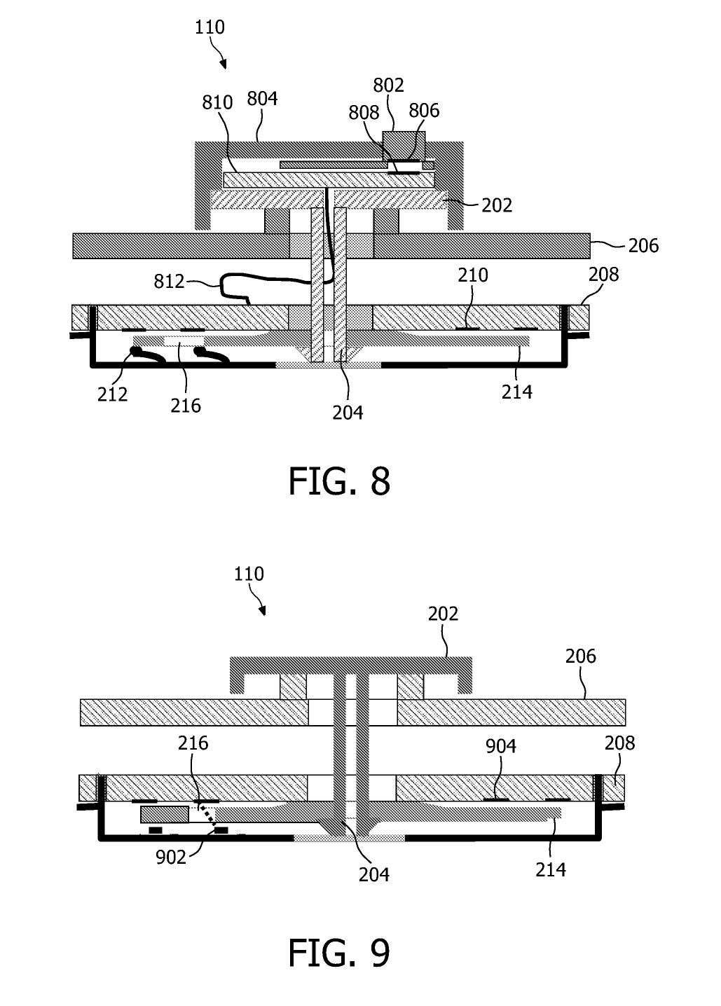

FIG. 8 illustrates a cross section of a second example of key 110. Key 110 comprises the configuration of the example in FIG. 2, but has an additional control feature 802 built in. A cap 804 covers disc 202 and accommodates control feature 802, here a push button for further control of apparatus 102 or cursor 106. Button 802 comprises contacts 806 and 808 that can be made to touch each other if button 802 is pressed. Contacts 806 and 808 are functionally a part of PCB 810 that connects to PCB 208 via a cable 812.

Above implementation rely on the resilience of individual ones of fingers 212 for their operation: without component 214 being present, fingers 212 would press against contacts 210. A similar functioning would be attained if fingers 212 were replaced with other elastic structures capable of being pushed away from contacts 210.

Above implementations show key 110 with contacts 210 arranged over fingers 212. If the orientation were reversed: fingers 212 over contacts 210, the operation would not change. However, in the reversed orientation one could use gravity instead of the finger's resilience to selectively have one of contacts 210 being touched through hole 216. Fingers 212 could then be replaced by conductive wires at the end of which is attached a small ball or the like.

Functionally, the key in the invention enables to selectively have facing elements (e.g., the contact-finger pair) communicating with one another in dependence on the relative position of component 214 obstructing or allowing the communication. Accordingly, implementations other than above mechanical ones are feasible. This is illustrated by way of example in FIG. 9.

FIG. 9 illustrates a key 110 in the invention wherein fingers 212 have been replaced by one or more light sources 902, and wherein light sensors 904 have replaced contacts 210. Sensors 904 and light source 902 have been configured in such a manner that a sensor 904 only receives enough light if component 214 does not block sensor 904, i.e., if hole 216 is properly positioned between source 902 and the associated sensor 904. In similar manner as with the implementations in FIGS. 1-8, the specific sensor receiving light is indicative of the position of disc 202 relative to housing 206. Sources 902 can be implemented using multiple light emitters properly positioned and oriented relative to sensors 904. Alternatively, sources 902 could be implemented using a single source, e.g., an illuminated area such as can be obtained using organic LEDs, etc. Specific one(s) of sensors 904 are then allowed to register light emitted by this area only if hole 216 is properly positioned relative to sensors 904. An advantage of this embodiment is that it is more easily scalable than the mechanical ones, wherein reliability and longevity impose certain minimum requirements on the dimensions of contacts 210, fingers 212 and holes 216. Furthermore, the critical parts in the optical implementation are not subjected to mechanical wear.

1. An apparatus comprising a multidirectional key moveable relative to a housing for converting a movement into a specific one of multiple directions into a signal representative of the specific direction, wherein:
the key comprises an arrangement of multiple first elements;
the key comprises a second element facing the first arrangement;
the key comprises a component between the second element and the arrangement and moveable with respect thereto;
the component is operative to selectively enable a specific one of the first elements and the second element to communicate with one another depending on a specific position of the component relative to the arrangement.

2. The apparatus of claim 1, wherein:
the second element comprises a second arrangement of multiple third elements;
the component is operative to selectively enable a specific one of the first elements and a specific associated one of the third elements to communicate with one another depending on the specific position of the component relative to the first and second arrangements.

3. The apparatus of claim 2, wherein:
each respective one of the first elements comprises a respective one of multiple contact;
each respective one of the third elements comprises a respective finger extending towards an associated one of the multiple contacts;
the component has a plurality of holes so as to selectively enable a specific one of the fingers to touch a specific associated one of the contacts through a specific one of the holes depending on the specific position of the component relative to the arrangements.

4. The apparatus of claim 3, wherein: the contacts are arranged along substantially a circle; the fingers are arranged in substantially a further circle; and the holes are arranged in substantially another circle.

5. The apparatus of claim 3, wherein the contacts are arranged along substantially a plurality of concentric circles; the fingers are arranged substantially along a plurality of further concentric circles; and the holes are arranged in substantially another circle.

6. The apparatus of claim 3, wherein the contacts are arranged along substantially a plurality of concentric circles; the fingers are arranged substantially along a plurality of further concentric circles; and the holes are arranged along substantially two or more other concentric circles.

7. A multidirectional key configured for use in the apparatus of claim 1.
